(19) United States
(12) Patent Application Publication
(10) Pub. No.: US 2025/0325941 A1
(43) Pub. Date: Oct. 23, 2025

(54) Systems and Methods for Pollution Control and Particulate Abatement for Use in Achieving Compliance with Regional Haze Regulations

(71) Applicant: AirTech Innovations, LLC, Federal Way, WA (US)

(72) Inventors: Steven A. Jaasund, Federal Way, WA (US); Robert S. Ward, Pittsburgh, PA (US)

(21) Appl. No.: 19/173,073

(22) Filed: Apr. 8, 2025

Related U.S. Application Data
(60) Provisional application No. 63/635,750, filed on Apr. 18, 2024.

(51) Int. Cl. B01D 53/86

(52) U.S. Cl. CPC B01D 53/8603; B01D 53/869; B01D 2251/104; B01D 2257/30; B01D 2257/80; B01D 2258/0283

(57) ABSTRACT

A method for cleaning gas flows generated by a combustion process. In one where continued use of coal as a source of heat input embodiment, this is accomplished by a multi-stage gas flow treatment that comprises treatment of a gas flow with ozone as a reactant to oxidize nitrous oxide and convert mercury to its oxidized form. This is followed by exposing the gas flow to one or more stages of a wet electrostatic precipitator (ESP) to substantially remove water and particulate matter from the gas flow. Among other benefits, the disclosed treatment process assists States to comply with regional haze reduction rules and regulations.

### CROSS REFERENCE TO RELATED APPLICATION

This application claims the benefit of U.S. Provisional Application No. 63/635,750, filed Apr. 18, 2024, entitled “Systems and Methods for Pollution Control and Particulate Abatement in Combustion Processes”, the disclosure of which is incorporated, in its entirety (including the Appendix) by this reference.

### BACKGROUND

Presently, a significant portion of the man-made point source combustion systems (such as used for generating electricity, as an example) in the US are based on using either coal, natural gas, oil, or biomass to generate heat input to various processes in the manufacturing and power generation industries, e.g., steam boilers, combustion turbines, kilns, or reheat furnaces. While abundant and relatively cheap, these fuels are known to be a significant source of pollutants including particulate matter, sulfur (sulphur) oxides, carbon monoxide (CO), and nitrogen oxides.

To address these emissions, the US Environmental Protection Agency (EPA) and local regulatory agencies have promulgated a variety of regulations that limit these specific air pollutants. Recently, the US EPA has promulgated rules for ambient air quality that will further reduce the allowable amount of fine particle emissions (for example, see https://www.epa.gov/pm-pollution/national-ambient-air-quality-standards-naaqs-pm). These regulations are also expected to provide a significant benefit in reducing regional haze.

Unfortunately, existing and proposed approaches to implementing air pollution control technologies that rely on the physical principles of interception and impaction are limited in their effectiveness at removing ultra fine discrete particles and condensation formation products. Such carryover products coupled with the use of ammonia as a reductant to achieve NOx reduction exacerbates the difficulty of maintaining the visual clarity of Class I areas.

While the conventional systems in place do a good job of abating much of the nitrogen oxide, particulate, and sulfur oxide emissions, there is normally a portion of emissions that escape into the environment. Typical examples of such emissions include very fine particulate matter, sulfuric acid mist that occurs when sulfur trioxide is hydrated in a wet FGD (flue gas desulfurization) system, carbon monoxide (CO), and ammonium salts that result from excess ammonia that escapes a deNOx process (e.g., from use of an SCR system or a selective noncatalytic reduction (SNCR) system).

These emissions are a significant problem for all types of solid and liquid fuel-fired emission sources because many of these facilities are also subject to other regulatory emission control mandates that go beyond specific limits at the smokestack or other gas flow discharge and often focus on harmful and in some cases, longer term downstream effects. Examples of such regulations are the US EPA Cross State Air Pollution Rule (CSAPR) and the US EPA Regional Haze rules.

In any of these situations, a reduction in emissions may be required to continue operation. Embodiments are directed to providing a solution to these and other disadvantages of conventional systems and methods for the reduction of pollutants in emissions from such processes, both individually and collectively.

### SUMMARY

The terms “invention,” “the invention,” “this invention,” “the present invention,” “the present disclosure,” or “the disclosure” as used herein refer broadly to all subject matter disclosed and/or described in this specification, the drawings or figures, and to the claims. Statements containing these terms do not limit the subject matter disclosed and/or described, or the meaning or scope of the claims. Embodiments covered by this disclosure are defined by the claims and not by this summary. This summary is a high-level overview of various aspects of the disclosure and introduces some of the concepts that are further described in the Detailed Description section. This summary is not intended to identify key, essential or required features of the claimed subject matter, nor to be used in isolation to determine the scope of the claimed subject matter. The subject matter should be understood by reference to appropriate portions of the entire specification, to any or all figures or drawings, and to each claim.

In some embodiments, the disclosed approach and related technology provide an effective and efficient air pollution control mechanism which can remove a wide range of particulate constituents that may be present in detached plumes from point source combustion systems. This will assist in achieving the long-term goals of the Regional Haze Rules and associated regulations and do so in a relatively shorter time frame and with less expenditure than construction of new facilities or modifications based on different approaches.

In some embodiments, the disclosure is directed to systems, methods, and apparatuses for cleaning gas flows (also referred to as air flows) generated by combustion processes. In one embodiment, this is accomplished by a multi-stage gas flow treatment that includes the injection of ozone (O₃) as a reactant to oxidize nitric oxide (NO, the predominant form of nitrogen oxide in most flue gases) to N₂O₅ and convert mercury to its oxidized form, both of which are water soluble. This enables removal of nitrogen and mercury compounds by wet scrubbing of the outgoing gas flow, such as by use of a flue gas desulfurization scrubber which can also remove the oxidized nitrogen oxides and mercury.

In one embodiment, this is followed by exposing the gas flow to one or more stages of an electrostatic precipitator (ESP) to remove particulate matter from the gas flow. In one embodiment, two separate ESPs or stages of ESP are utilized, with at least one being a “wet” ESP stage having tube-type electrodes through which the gas flow is directed. A benefit of the disclosed and/or described approach is that it may be appended to an existing combustion flow treatment system without interruption to the other aspects of the combustion process.

As a non-limiting example of an implementation of the disclosed approach, in one embodiment, a method for reducing particulate matter and other forms of pollution in the air or gas flow from a combustion process may include the following steps, stages, functions, processes, or operations:
Introduce ozone into a gas flow produced as an output of a combustion process—this may be done by producing ozone using an external ozone generator. The ozone is introduced into a stage of the existing gas flow treatment system (typically downstream of any existing SCR equipment and in a region of the gas or airflow treatment pipeline where the gas/air temperature is less than approximately 350 degrees Fahrenheit). The existing SCR equipment may be deactivated by removal of the catalyst and form a drop-out chamber, or instead may be removed;
   An existing gas flow treatment system may include a dry electrostatic precipitator (ESP) or a fabric filter (bag house). If a deactivated SCR is not used as a drop-out chamber, then either of these or other treatment apparatus are expected to provide the necessary residence time for the introduced ozone to react with the nitrogen oxides;
The gas flow that exits the dry ESP or fabric filter is then passed into a wet flue gas desulfurization apparatus (FGD) designed to absorb and remove sulfur dioxide SO₂;
Next, direct the gas flow (after introduction of the ozone and reaction in upstream equipment) exiting the FGD apparatus into a first stage of a wet ESP to remove liquid water from the gas flow produced as an output of a combustion process;
   In some implementations, an existing mist eliminator system and/or other particle removal apparatus in the outlet of the FGD apparatus (where the outlet may be termed a stack or vessel) may be removed prior to installation of the first stage of the wet ESP. In such implementations, the first stage (and if space permits, a second stage) of the wet ESP may be placed within the footprint of the FGD vessel during a retrofit process;
   In such implementations, the first stage of the wet ESP will replace the function of a mist eliminator system, thus providing a reduced pressure drop, and increased reliability/availability;
Direct the output of the first stage of a wet ESP into a second stage of a wet ESP to remove fine particulates (e.g., mercury or heavy metals) from the gas flow output by the first stage of the wet ESP device; and.
Direct the output of the second stage of the wet ESP into an absorber designed to remove CO₂ or other pollutants from the gas flow, and then into a smokestack or other component to release into the environment;
   In one embodiment, the output of the second stage of the wet ESP may be directed into a smokestack and treated further prior to release into the environment;
   In another embodiment, the output of the second stage of the wet ESP may be directed into a CO₂ absorber or scrubber and the output of the absorber or scrubber directed into a smokestack before release into the environment.

Other objects and advantages of the systems, apparatuses, and methods disclosed and/or described herein may be apparent to one of ordinary skill in the art upon review of the detailed description and the included figures. Throughout the drawings, identical reference characters and descriptions indicate similar, but not necessarily identical, elements. While the embodiments disclosed and/or described herein are susceptible to various modifications and alternative forms, specific embodiments are shown by way of example in the drawings and are described in detail herein. However, embodiments of the disclosure are not limited to the exemplary or specific forms described. Rather, the present disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1(a) is a diagram illustrating the components, elements, or processes used in a conventional gas flow cleaning system in a thermal power generating process prior to the treated gas flow being released into the environment;

FIG. 1(b) is a diagram illustrating a set of tubes or cylindrical electrodes forming a first and second stage wet electrostatic precipitator that may be placed into a gas flow generated by a combustion process as part of implementing an embodiment of the disclosure;

FIG. 1(c) is a diagram illustrating components, elements, or processes that may be used to implement an embodiment of the disclosed approach for reducing emissions and particulate matter from combustion process gas flows; and

FIG. 1(d) is a flowchart or flow diagram illustrating a set of steps, stages, processes, operations, or functions that may be used to implement an embodiment of the disclosure.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Further, one or more embodiments of the disclosure are described herein with reference to the accompanying drawings, which form a part the disclosure, and which show by way of illustration exemplary embodiments by which the disclosure may be practiced. The disclosure may, however, be embodied in different forms and should not be construed as limited to the embodiments set forth herein. These embodiments are provided so that this disclosure will satisfy the statutory requirements and convey the scope of the disclosure to those skilled in the art.

Embodiments are directed to a retrofit to existing combustion processes that generate pollutants, specifically sub-micron particulate matter, nitrogen oxides (NOx), mercury (Hg), carbon monoxide (CO), and other heavy metals from fossil-fueled fired processes, such as coal-fired boilers utilized in electric power generation. In one embodiment, the disclosed and/or described retrofit components may be applied to a coal-fired boiler equipped with a wet scrubbing system used for the collection of sulfur oxides (such as an FGD). Embodiments may also be used to provide a level of cleanliness necessary for the effective downstream treatment of the gas stream/flow by a CO₂ scrubbing system.

Common features of the forms of heat input conventionally used to generate electricity or perform an industrial manufacturing process include: (1) the inherent capability to provide base loaded power generation to ensure the reliability/availability of the power grid in the absence of sufficient renewable sources of energy; and (2) the use of ammonia as a reagent additive to facilitate reducing nitrogen oxides to allowable regulated levels.

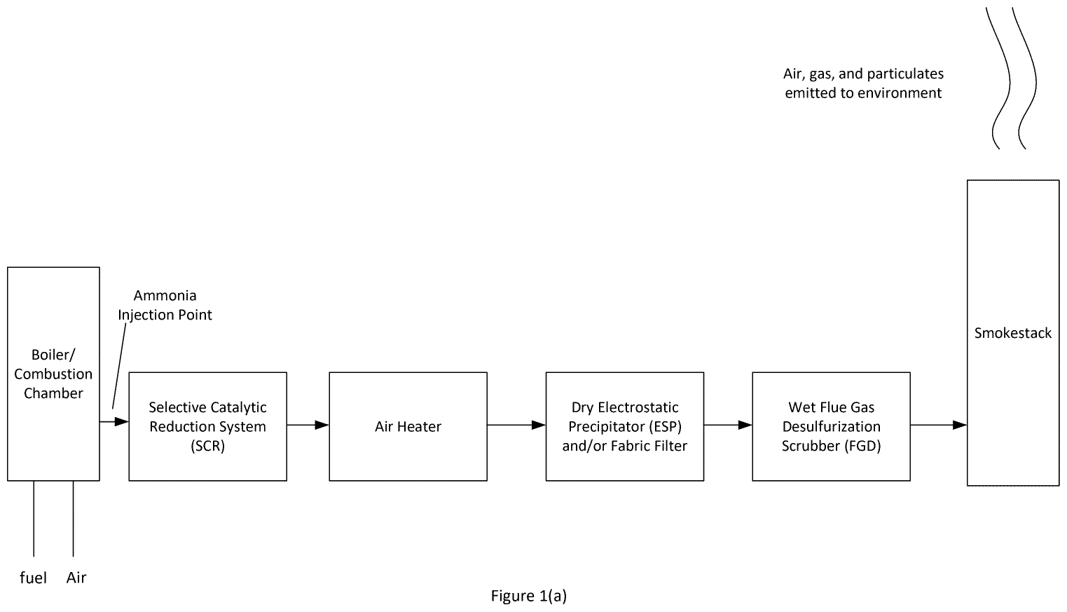

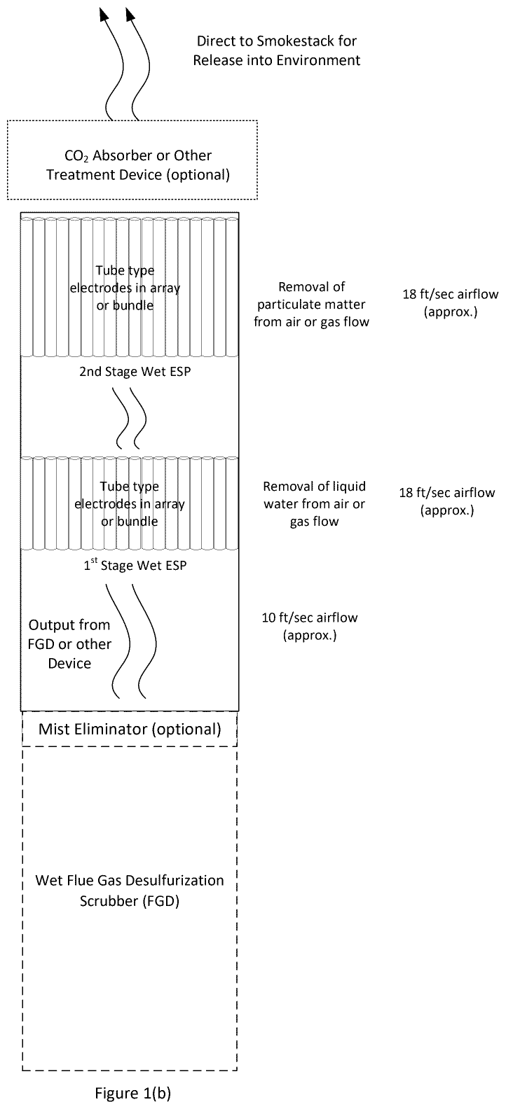

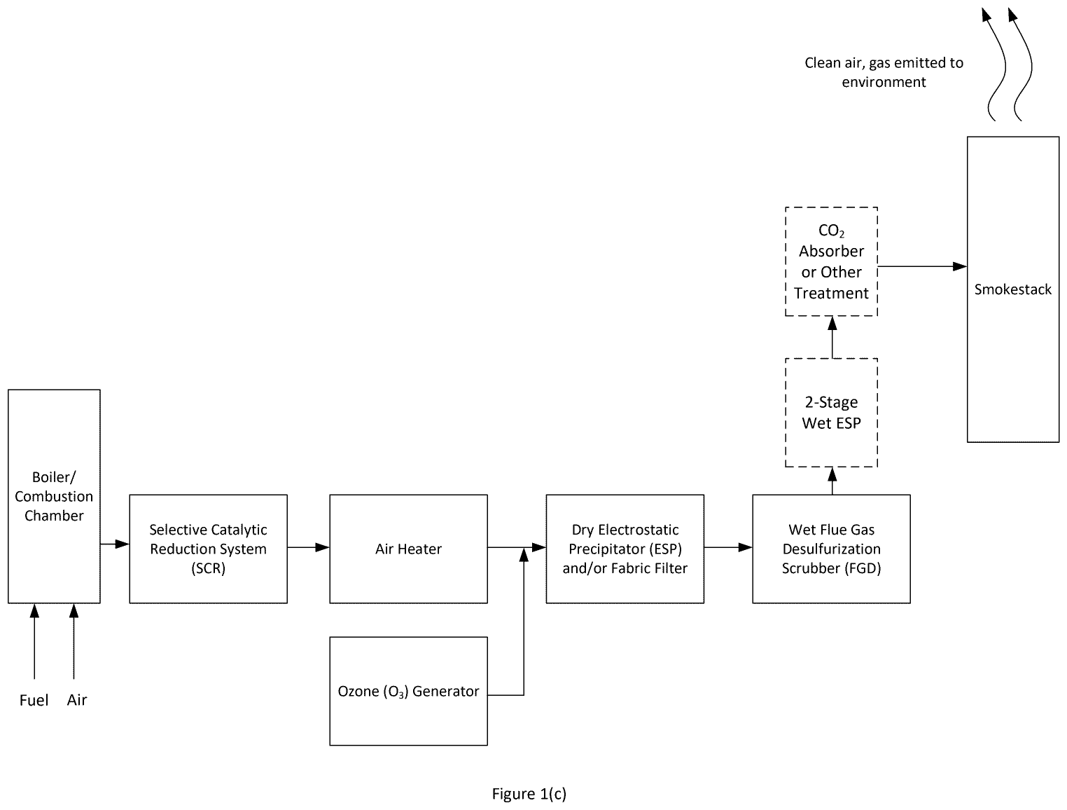

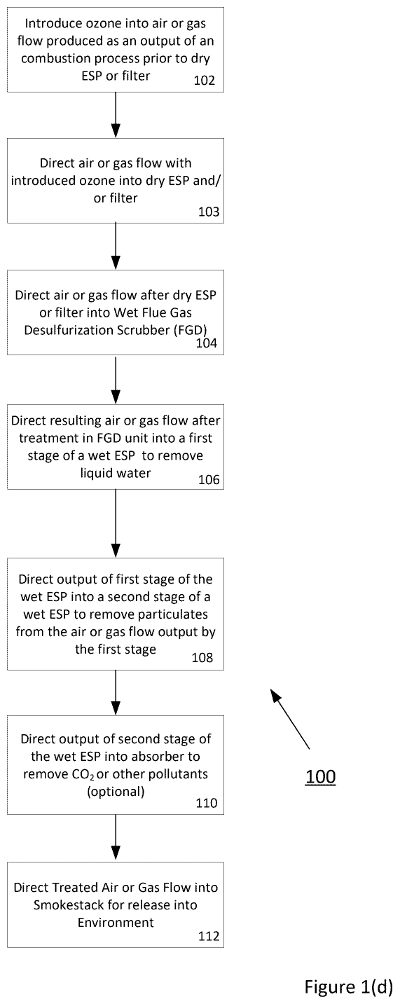

Further, a typical coal-fired electricity generating facility may have a dry electrostatic precipitator (ESP) or a fabric filter for the capture and control of particulate emissions, a selective catalytic reduction (SCR) device for the control of nitrogen oxides, and a wet scrubber for the control of sulfur oxides (as are illustrated and described with reference to FIG. 1(a)).

Existing and proposed regulations may require many existing facilities to install much larger and relatively expensive modifications to an existing SCR for NOx and/or install activated carbon injection (ACI) systems for mercury (Hg), and if not, risk being shut down. New or modified Federal, State, or Regional regulations may also require more restrictive controls on the emission of very fine particulates, which act as condensation nuclei exacerbating the formation of regional haze downstream of the emission source.

As one example, the new or modified 2.5-micron particle specific regulations may assist in reducing pollution and haze in at least two ways. First, particles of this size refract (scatter) light thus contributing to reduced visibility and clarity of the atmosphere. In addition, new particle formation (typically nano particle sized detached plume formation) can act as condensation nuclei which the Regional Haze Rule is trying to reduce.

With regard to Regional Haze Rule(s), each State develops a Regional Haze Implementation Plan which is revised periodically. As part of this plan, a list of emitters is identified that impact regional haze each State provides interim solutions via periodic Regional Haze State Implementation Plans (SIPs) submitted to the US Environmental Protection Agency (EPA). The disclosed technology provides a solution to enable achieving national, state, and regional visibility goals.

Further, current concerns about climate change are driving operators of thermally based electric generation facilities to consider installing carbon dioxide (CO₂) scrubbers downstream of existing emission control equipment. Effective use of such scrubbers may require that the incoming gas stream be significantly cleaner than the gas stream would be if only intended to comply with present emission control regulations.

To address these concerns and the limitations of conventional approaches, in one embodiment, the disclosure is directed to a process that utilizes ozone (O₃) as a reactant to oxidize nitric oxide (NO, the predominant form of nitrogen oxide in most flue gases) to N₂O₅ and convert mercury to its oxidized form, both of which are water soluble. These soluble species may then be removed by a wet scrubber, although further removal of oxidized species (if present) may also occur during the operation of a downstream wet ESP device or apparatus.

The use of ozone as an oxidant is expected to eliminate the need for traditional NOx abatement equipment such as selective catalytic reduction systems (SCRs) and selective non- catalytic reduction (SNCR) systems in processes used in the manufacturing and power generation industries. Examples of components used in such industries and whose operation may benefit from implementation of an embodiment of the disclosure include but are not limited to steam boilers, combustion turbines, kilns, and reheat furnaces. For example, a furnace combustion process can be optimized to minimize formation of carbon monoxide and unburned carbon.

The disclosed retrofit approach will also eliminate the use of ammonia and the attendant health risks associated with the transport, storage, and use of this chemical. Use of ammonia in particular represents a hazard as it is a significant contributing factor in the formation of ammonium salts which reduce the clarity of the atmosphere. In some embodiments, the SCR or SNCR system or components may be removed, with the added benefit of reducing the pressure drop through portions of the overall system.

The reduced need for use of ammonia has been recognized as a desired goal. In this regard, the US EPA recognizes the role that ammonia plays in the formation of non-methane hydrocarbons (e.g., formaldehyde) along with the formation of regional haze, and requested that the States consider this in developing their State Regional Haze Implementation Plans.

In coal-fired electrical generating units, this will eliminate the reliability and reduced availability issues associated with the presence of catalytic material used in SCRs, which are prone to cause load reduction due to unacceptably high draft loss and problems such as catalyst fouling/poisoning. This will significantly benefit the operators of the thermal power generating facilities by minimizing the potential for brownout/blackouts that occur during wintertime polar storm events and summertime high demand/high ambient temperature periods. In addition, the use of ozone as an oxidant will eliminate the out of compliance periods associated with cold- start-up of the generating unit.

In one embodiment, the disclosure is directed to an add-on or retrofit wet electrostatic precipitator (ESP) for further and more complete reduction/removal of sub-micron particulate matter that has not been captured or otherwise removed from a combustion process output gas flow by an existing dry ESP and wet scrubber treatment system. In one embodiment, the disclosed wet ESP is a tube-type unit operating in an up-flow mode. In one embodiment, the wet ESP element or component is fitted on top of a flue gas desulfurization (FGD) scrubber unit and within its perimeter. In another embodiment, the two-stage wet ESP device or apparatus may be separate from the FGD unit and arranged or oriented so that the air or gas flow output by the FGD unit is passed upward into and through the stages of the wet ESP.

The proposed approach is expected to be significantly less disruptive and more effective than use of much larger SCR+activated carbon injection (ACI) type approaches because it would not require interruption of an existing flue gas treatment system. In this regard, an embodiment of the disclosed equipment and gas or air flow processing would be installed outside of the existing flue gas treatment system and tied into the outflow gas stream during a relatively brief outage in operations.

An embodiment of the disclosed and/or described components, elements, or process may be applied to an existing gas or air flow where the flue gas is being treated with a dry electrostatic precipitator for fly ash control and a wet scrubber (FGD) for sulfur dioxide control. An embodiment utilizes ozone (O₃) to oxidize nitric oxide (NO, the predominant form of nitrogen oxide in most flue gases) to N₂O₅ and convert mercury to its oxidized form, both of which are water soluble. These soluble species may then be removed in a wet scrubber (such as a FGD unit), with further removal (if necessary) occurring during the transit of the air or gas flow through the wet ESP. In embodiments where ozone is introduced into the air or gas flow, the SCR chamber is no longer used (if still present) for deNOx control. This may eliminate the need for a SCR device and its accompanying disadvantages. A description of the approach of using ozone as a reactant is contained in “Report on the Pilot Demonstration Testing of LoTOx Integrated Environmental Controls for the Simultaneous Removal of NOx and Mercury in Flue Gas Desulfurization Scrubbers at Great River Energy's Coal Creek Station, Underwood, ND Oct. 27 to Nov. 5, 2003”.

The capability of ozone to participate in both of these oxidation reactions is established but requires a sufficient amount of process gas/ozone residence time in a region to complete the desired reactions. However, as disclosed, the presence of an existing, downstream, dry electrostatic precipitator or fabric filter may be used to provide sufficient residence time for the oxidation of both the NO and Hg to proceed after the introduction of ozone. The removal of the NO and Hg oxidized species would be accomplished in an existing, downstream, wet scrubber (such as an FGD) because these oxidized compounds are water soluble.

As described herein, implementing the disclosed process does not require the interruption of the existing flue gas transport and treatment equipment. This is a significant advantage as ductwork, fans, or ESPs, are but some examples of components that may have to be at least temporarily shut down or altered when using conventional approaches. This advantage is obtained because the necessary new equipment (such as the ozone generation equipment) may be located nearby or in some cases remote to the existing flue gas conveyance and treatment equipment with only a simple injection distribution array (i.e., piping) required for implementation and introduction of the ozone into the gas flow.

In addition, the disclosed approach does not suffer from the disadvantages associated with the use of ammonia with SCR systems. Ammonia is a necessary element in both SCR and SNCR systems but creates two important problems. The first is the inevitable “ammonia slip” which is the amount of untreated ammonia that is discharged into the ambient air. Ammonia slip is considered nitrogen oxide emissions by regulatory agencies because ammonia ultimately oxidizes to smog-causing NOx in the environment.

A second problem is that untreated ammonia is known to react with several acidic emissions downstream of a scrubber system to form a noticeable detached plume of ammonium salts, such as ammonium chloride or ammonium sulfate. These emissions are rigorously controlled by US EPA Regional Haze Rules and will be further restricted by new ambient air quality standards introduced by the US EPA. In contrast, the disclosed and/or described approach does not suffer from these problems because it relies on ozone as a reactant, and not ammonia.

In one sense, embodiments provide a cost-effective and efficient way of retrofitting existing electrical power generating facilities that rely on the combustion of a fuel that releases large amounts of particulate matter. This is particularly beneficial as air pollution controls become more stringent. Embodiments also reduce risks associate with the use of ammonia while reducing emissions of nitrogen oxides and mercury into the ambient air.

The disclosed improvements to conventional approaches for treating air or gas flows emitted by power generating or industrial manufacturing facilities may enable those facilities to remain in operation as air pollution control requirements develop over time. In addition, embodiments may be augmented by further pollutant controlling components, such as scrubbers, filters, or other air or gas flow treatments. A further benefit or advantage is that embodiments are expected to improve the operation of CO₂ absorbers, as such devices typically require extremely clean air or gas flows to operate most efficiently.

An embodiment of the disclosure may include an add-on multi-stage wet ESP for further reduction of sub-micron particulates that were not captured in an existing dry ESP and/or wet scrubber (FGD) system. This can be very valuable, as the emission of uncaptured particulate emissions may make it very difficult for a power generating facility to comply with EPA Regional Haze and other regulations.

In one embodiment, each stage of the disclosed two-stage wet ESP would preferably be a tube-type unit comprising cylindrical electrodes and positioned or operating so that the gas flow is vertically upward through the ESP device. In one embodiment, the two-stage wet ESP may be fit on top of a flue gas desulfurization (FGD) scrubber unit or vessel and within its perimeter to receive an upward air flow exiting the FGD unit. If not fit on top of the FGD unit, the air or gas flow exiting that unit may be directed upwards through the tubular elements of the ESP device or devices by properly sized and oriented conduits or ductwork.

FIG. 1(c) is a diagram illustrating components, elements, or processes that may be used to implement an embodiment of the disclosed approach for reducing emissions and particulate matter from combustion process gas flows. The Figure also shows the arrangement of typical air pollution control equipment and orientation of air or gas flow therein. As shown, a 2-stage wet ESP device or apparatus is placed on top of the FGD unit. The output of the ESP device or apparatus may then be treated further by a CO₂ absorber (or other treatment process) prior to the cleaned air or gas flow being directed into a smokestack for release into the environment.

A challenge of this approach of mounting a wet ESP on top of a FGD component is that the gas stream exiting the scrubber may flow upwardly at a velocity that is too high for effective treatment. For example, the outlet bulk upward gas velocity from FGD scrubbers is typically greater than 10 ft/second (˜6.8 mph). Upon entering the round tubes of a top-mounted wet ESP device this flow velocity will increase because an array of round tubes would have less cross-sectional flow area than the exit or output of the FGD scrubber. As a result, the air or gas flow velocity will increase and depending on the initial velocity and dimensions of the electrodes in the ESP, may increase to a value that is normally prohibitively fast for effective treatment by a conventional implementation of a wet ESP, i.e., >14 ft/sec (˜9.5 mph).

While a single state wet ESP with tube electrodes could still be partially effective in removing particles, its operation will be constrained by the entrained water droplets. However, as recognized by the inventors, introduction of a second stage wet ESP can be used to augment the partial effectiveness of a single stage wet ESP and provide an effective solution.

A reason that approximately 14 ft/sec (or greater) is normally considered the maximum velocity for effective use of such a wet ESP (i.e., one incorporating an array of round electrode tubes) is that a higher velocity will cause collected liquid droplets from the FGD scrubber to be peeled off the collecting surface of the electrode, re-entrained in the flow, and initiate sparking at lower than maximum voltage. Such lower voltage sparking will reduce the overall particle collection performance of the wet ESP.

In addition, at a gas or air flow velocity greater than 14 ft/sec, large water droplets from the wet scrubber (FGD) below will be entrained. Larger entrained droplets may cause a significant disruption in the electrical field established within the electrode and also result in sparking. Both situations will tend to lower the operating voltage of a wet ESP and reduce its effectiveness and efficiency. The operating air/gas flow velocity is important, as a higher velocity than 14 ft/sec would often be expected from the output of a FGD unit for both process and economic reasons.

Based on consideration of vapor pressure, typically liquid water cannot be found in droplet form smaller than approximately 1 micron in diameter. Droplets in the size range of 1 micron or greater are very easy to collect in an electrostatic precipitator, even at lower voltages and brief(er) treatment times. Given the above considerations, a solution to this problem recognized by the inventors is to add a second stage of a wet ESP to the components treating a gas or air flow. With this arrangement, the liquid water will largely (if not completely) be collected in a first stage so that the second stage can operate at its maximum voltage without the liquid water entrainment problem. In one sense, the second stage ESP is operating on a gas stream that is free of liquid water, even if fully saturated with water vapor.

The inventors also recognized the benefit of placing such a two-stage wet ESP on top of an existing FGD scrubber because of the inherent economy and space efficiency of such an arrangement. More specifically, such an arrangement is more compact and does not require as extensive use of conduit, ductwork, or other components to direct the air or gas flow upward through the tubular electrodes compared to a ground mounted wet ESP located aside the existing FGD unit. As mentioned, placement of a wet ESP within the vessel or stack of a FGD may require removal of a portion or all of the components of an existing mist eliminator. However, the first stage of a wet ESP effectively replaces the mist eliminator and performs a similar function.

With no liquid water present and a relatively low concentration of other particulate matter, the second stage wet ESP can operate at very high gas velocities and at very high voltage levels. Because of this, a second stage can be extremely efficient in removing pollutants from the flue gas stream (as illustrated and described with reference to FIG. 1(b)).

As recognized by the inventor(s), adaptation of the tube-type ESP design for this use case is particularly beneficial because of the unique performance characteristics of this design. For example, the reader is referred to U.S. Pat. No. 4,093,430 issued Jun. 6, 1978, U.S. Pat. No. 4,110,086 issued Aug. 29, 1978, and U.S. Pat. No. 4,194,888 issued Mar. 25, 1980; each describe aspects of a disk-in-tube type electrode arrangement for generating a strong electric field. The disk-in-tube arrangement enables the development of a high voltage corona at very high field strength. This is because the arrangement allows a very highly focused electric field at the cathode with a very diffuse and uniform electric field at the anode, thus preventing arc-over until extremely high electric field strengths are reached. For example, in laboratory operation an electric field value of over 30 kV/inch has been achieved.

The capability of generating a relatively high electric field is a factor in using “wet” ESP based filtering in the field of air pollution control. The technology has been used to abate emissions from industrial processes that tend to emit significant concentrations of fine particulate matter. However, the “wet” ESP units used have been relatively large machines designed to deal with rapid accumulation of collected particulate matter and other factors present in the abatement of manufacturing process emissions. As a result of these factors, the typical electric field strengths achievable have been in the range of 20 kV/inch (which is still higher than other, conventional, wet ESP designs).

However, the ESP technology has not found widespread use in cleaning emissions emanating from an FGD absorber and, in particular, within the circumference and on top of an FGD absorber vessel. A possible reason for this lack of use is that conventional thought is that the airflow or airstream velocity exiting an FGD absorber would be too high to allow an effective operating voltage for an ESP filtering device.

Note that if used for the application described herein, the disk-in-tube electrode configuration is expected to be capable of achieving electric field strengths that more closely resemble the laboratory achieved level of 30 kV/inch, rather than the industrial experience of 20 kV/inch. This is because in the environment in which the electrodes are used, they will be operating on air which is one to two orders of magnitude cleaner than process gases. Further, the proposed design will be fabricated as a much smaller and more tightly aligned machine than its larger and less precise industrial cousin(s). Use of a two-stage wet ESP on top of (or within the confines of) an FGD absorber results in the first stage in effect being a “sacrificial” stage that removes the liquid water so that the second stage can more effectively remove fine particulate matter.

The higher achievable field strength is a significant factor because the particle migration velocity (i.e., the velocity vector normal to the gas direction) increases as the square of the field strength. Thus, the migration velocity at 30 kV/inch is approximately 2.25 times the migration velocity at 20 kV/inch. This factor also applies to the ESP (precipitator) size, so that a precipitator operating at the higher field strength would be this factor smaller than one operating at 20 kV/inch (relative size=1/2.25=44.4%). This is a further factor supporting use of the disclosed system as a higher electric field gradient provides the benefit of more effective airstream filtering while making the device more feasible to use in multiple operating environments and systems. The combination of reduced size coupled with increased electric field gradient provides both better performance and greater feasibility in certain use cases or operating environments.

In some embodiments a purpose of a first stage of a wet ESP is to ensure that free moisture is removed so that the second stage can provide the highest degree of separation efficiency possible for the removal of sub-micron condensed salt formations or other particulate matter. Thus, although one or more examples of a suitable form of a wet ESP are disclosed and/or described herein, embodiments are not limited to those examples and a wet ESP may be implemented using other forms of elements and operated within a range of operating conditions.

Among others, motivation for the development and the configuration of the components of one or more embodiments as disclosed and/or described herein include the following:
New pollution control regulations requiring removal of smaller particulates from air emitted by power generating and other manufacturing processes;
A continuing and increasing need for electrical power partly due to use of new technologies (e.g., server farms);
   In this regard, being able to retrofit existing power generation facilities instead of constructing new ones is both more cost-effective and more likely to make needed power available in the short term;
Alternative sources of power such as renewables are not always as reliable or available in sufficient amounts—this increases the desirability of using existing coal-fired plants if the concerns regarding particulate matter, acid rain, and haze can be addressed; and
Costs involved in redesigns and construction of new coal-fired plants and associated cleaning elements for airflow may be substantial.

Given these concerns and the cost and timing issues, embodiments provide a solution that may be implemented in multiple ways:
Adding a two-stage wet ESP to the existing gas or air flow;
   In some arrangements or configurations, this may require redirecting the gas or air flow and introducing the redirected flow into a wet ESP using an appropriate set of ductwork or conduits;
   In some cases, it may be desirable or necessary to place the first and/or second stages of the wet ESP apart from and not within the FGD vessel/absorber;
      While possible, this is generally not as economical as placing both stages within the footprint of the FGD vessel after removal of the existing mist eliminator components;
      While a single stage wet ESP can be placed on top of an FGD scrubber or other component, it is expected that the gas or air flow velocity at the top of a FGD device may be too great for a single stage wet ESP to be effective enough;
Based on these considerations, an embodiment of the inventive solution is a two-stage wet ESP placed on top of an FGD scrubber (as an example location), with the wet ESP being constructed from an array of tubular elements. The gas or air flow exiting the FGD unit is directed upward into and through the array of tubular elements or electrodes. In one example of the operation of such a device:
   A first stage of a two-stage wet ESP removes substantially all moisture in the form of water droplets in the air or gas flow;
   A second stage of the two-stage wet ESP removes substantially all particulate matter (and can be augmented by an absorber or other treatment);
   When the wet ESP incorporates an array of tube electrodes, this solves the recognized disadvantages of conventional approaches both economically and effectively, and can operate efficiently at the expected range of gas or air flow velocities exiting an FGD unit;
Further, by introducing ozone into the gas or air flow at the appropriate location, the result is to reduce constituents contributing to Regional Haze formation and the elimination of the use of ammonia based deNOx technologies.

Note that there is a holistic perspective involved in the development of the disclosed solution and its implementation in the form of one or more embodiments. This requires an understanding of both Advanced Pollution Control (APC) technology and also the conflict between the US EPA regulatory actions and the needs of the Regional Transmission Organizations (RTOs), which exist to insure the integrity of the domestic power grid. A need for relatively large apparatus (steam turbine/generator sets) to adequately insure voltage and frequency stabilization of the power grid has been recognized. However, current and proposed EPA regs are forcing retirement of such facilities (such as coal-fired power plants). Going forward, these same sets of EPA rules and regulations will affect other smokestack industries in addition to those involved in power generation.

An aspect of the disclosed approach is that use of a two-stage wet ESP in tandem with other disclosed technologies (e.g., ozone substitution in lieu of the use of ammonia vis-a-vis NOx control) provides an effective and cost-efficient retrofit technology. In embodiments in which the disclosed and/or described approach is implemented as an adjunct to an existing gas or air flow from a combustion process, it is believed the two-stage wet ESP configuration addresses the existing and proposed EPA Regulations regarding NOx and PM 2.5, and the Regional Haze Rule. As a result, the disclosed and/or described approach provides an acceptable way for thermal power generation and other affected smokestack industries to continue operation and comply with air-quality regulations.

For example, the use of ammonia as a reagent coupled with the presence of very fine particulate emissions (PM 2.5), and in some situations the formation of nano particles which act as condensation nuclei leading to the formation of ammonium salts, serve to exacerbate the formation of detached plumes, which can prolong the continued violation of the US EPA Regional Haze Rules. The reduction of these constituents is extremely important due to the potential impact on environmentally sensitive areas such as national parks, waterways, and tribal nations. This is an example of a situation that can be more effectively addressed using an embodiment of the disclosed approach as a retrofit for treatment of gas flows generated by an existing combustion process.

As a non-limiting example, an embodiment of the disclosed and/or described process for pollution control and particulate abatement may comprise the following set of steps, stages, functions, processes, or operations:
Introduce ozone into a gas flow produced as an output of a combustion process-in some example implementations, an existing SCR device (with the catalyst removed) may be used as a pass-through or drop-out chamber for the air or gas flow;
   Boiler efficiency and power generation, as well as system down-town may be improved by use of an embodiment since use of ozone and reduction or elimination of the use of ammonia contribute to reducing NOx and improving combustion processes;
   Further, a benefit of removing large particle ash from cleaning upstream processes is an improvement to the reliability/availability of downstream heat transfer equipment;
As an example, the gas flow into which the ozone is introduced may be directed into a dry ESP and/or fabric filter. The gas flow exiting that component is then directed into a wet flue gas desulfurization scrubber (FGD) designed to absorb and remove sulfur dioxide SO₂;
The air or gas flow exiting the FGD unit is then directed into a first stage of a wet ESP to substantially remove liquid water from the gas flow produced as an output of a combustion process;
Next, direct the output of the first stage of a wet ESP into a second stage of a wet ESP to substantially remove particulates from the gas flow output by first wet ESP device; and
Direct the output of the second stage of the wet ESP into a CO₂ absorber (and/or other treatment device) designed to more fully remove CO₂ or other pollutants before allowing the treated gas or air flow to be released into the environment (typically, after direction into a smokestack).

FIG. 1(b) is a diagram illustrating a set of tubes that may be used to form a first and second stage wet electrostatic precipitator that may be placed into an air or gas flow generated by a combustion flue gas as part of implementing an embodiment of the disclosure. In one embodiment, the set of tube electrodes may be arranged into an array or bundle. As shown in the diagram, in one embodiment, an existing FGD device is fitted with two stages of a wet ESP, where the ESP is implemented as a set of tubular elements through which the gas flow is directed upward.

In one embodiment, the air or gas flow in the FGD vessel (or stack or tower) may first pass through a mist eliminator or mist reducing element or process. In one embodiment, a scrubber tower may be a component of a FGD unit through which the treated flow passes, with the two-stage wet ESP being placed on top of the tower or within its confines after removal of components that are part of a mist eliminator.

The air or gas flow emanating from the outlet of the existing SO₂ scrubber (the FGD) tower will contain some quantity of entrained liquid droplets. These droplets will be collected by the first stage section of the two-stage wet ESP. At the relatively high velocity of the gas passing through this stage of the wet ESP due to the FGD unit flow velocity range, the liquid will collect on the electrode surfaces. The collected liquid will tend to disrupt the high voltage and limit the electric field that can be maintained between the discharge and collecting electrodes. As a result, the first stage of the wet ESP, while effectively capturing entrained liquid droplets, will be less effective in collecting fine, sub-micron particles and removing them from the air or gas flow. However, even at the reduced electric field intensity the first stage will provide a high level of collection for water droplets which are inherently large in diameter and easier to collect.

As mentioned, an additional effect of the first stage of the wet ESP is that it will allow the removal of an existing mist eliminator which is typically present at the exit of an FGD absorber. This is an advantage because it will reduce the system overall pressure drop (even with the addition of a wet ESP) and eliminate the problem caused by the tendency for a mist eliminator to become blocked with buildup.

To achieve the desired collection of hard to collect submicron particles, in some embodiments, a second stage of the wet ESP is added. Because the liquid present at the entrance of the first stage will not be present in the air or gas flow entering the second stage, the second stage electrode fields will be able to operate at much higher voltage levels and be more effective in collecting fine particles. Further, the second stage provides reduction of nano particle salt formation, which reduces formation of regional haze.

As a non-limiting example of an embodiment, the air or gas flow exiting the FGD unit is directed into a first wet ESP stage constructed of an array or set of tubular or cylindrical elements. Each tubular or cylindrical element incudes a central electrode surrounded by a cylindrical tube constructed to function as a second electrode, with a voltage/potential difference applied between the two electrodes. The voltage difference creates a potential within the tube/cylinder which ionizes the gases in the air or gas flow, causes removal/collection of water droplets, and causes some of the charged particulate matter to be collected on the walls of the cylindrical tube electrode.

The output of the first wet ESP stage is directed through a second wet ESP stage, again constructed of an array or set of tubular or cylindrical elements. As disclosed and/or described herein, the second stage operates to further remove particulate matter from the air or gas flow prior to it being discharged into the environment.

Further, as mentioned, injection of ozone and use of the disclosed two-stage ESP in the air or gas flow is expected to eliminate the need for use of the SCR and thereby reduce potential harm from the ammonia reactant typically used with a SCR process. As mentioned, in some installations or implementations, an existing SCR may be deactivated by removal of the catalyst and serve as a drop-out chamber for the air or gas flow or may be removed.

Although one or more examples of a suitable form of a wet ESP are disclosed and/or described herein, embodiments are not limited to those examples and a wet ESP may be implemented using other forms of elements and operated within a range of conditions (such as the voltage across the electrodes, air or gas flow velocity, or additional filtering or treatment stages). As an example, although a plurality of tubular or cylindrical elements or electrodes are disclosed as one embodiment of a component of the wet ESP device, other forms or shapes of elements and arrangements of those elements may be utilized, although they may not be as effective. It is important to select such element shapes and operating conditions to prevent reduction of the gas flow through the ESP to a level that is insufficient to be practical in a desired application or use case.

FIG. 1(c) is a diagram illustrating components, elements, or processes that may be used to implement an embodiment of the disclosed approach for reducing emissions and particulate matter from an air or gas flow generated by a combustion process. As shown in the diagram, the boiler output gas flow is directed to an air preheater. Inserted between the air preheater and an existing dry ESP stage or fabric filter is an output from an ozone (O₃) generator which would include the necessary ozone piping distribution array placed at a position between the air preheater and the existing dry particulate air pollution control device (i.e., the dry ESP and/or fabric filter). This can be accomplished during a brief tie-in time period as part of a routine planned maintenance outage and would be expected to require only a brief process shutdown.

Following the dry ESP stage or fabric filter, the air or gas flow may be passed into a SO₂scrubber (the Wet Flue Gas Desulfurization Scrubber (FGD) shown in the figure) to remove or at least reduce sulfur dioxide from the flow. Next the air or gas flow is passed through a first and a second wet ESP stage, as disclosed and/or described herein. The resulting cleaned flow may then be passed through a CO₂ absorber or other form of treatment (if desired or needed to comply with air quality regulations). Note that as air quality regulations or practices change over time, additional forms of absorber, scrubbers, or other treatment may be applied to the air or gas flow exiting the two-stage ESP or an existing CO₂ absorber.

Note that although the 2-stage wet ESP device is shown in the figure as being placed on top of (or within the confines of) an existing FGD unit or other form of air or gas flow structure, the 2-stage wet ESP may instead be placed on the ground separate from the FGD unit and alongside an existing smokestack. In such an example placement, the output of the FGD component may be directed into the 2-stage wet ESP, with the output of the 2-stage wet ESP then directed into the smokestack. Typically, an existing FGD device may have an associated tower or other form of exhaust or output (referred to as a vessel or absorber vessel), and the two-stage ESP may be placed on top of (or within the confines of) that element or component. As mentioned, in some cases, this may require removal of components of an existing mist eliminator. To maximize the effectiveness of the disclosed embodiments, the gas or air flow exiting the FGD unit is preferably directed upward into the tubular elements of the wet ESP.

FIG. 1(d) is a flowchart or flow diagram illustrating a set of steps, stages, processes, operations, or functions, 100, that may be used to implement an embodiment of the disclosure. As shown in the diagram, in one embodiment, a method to control pollutants created as a result of a combustion process may include:
Introduce ozone into an air or gas flow produced as an output of a combustion process. This may be done by producing ozone from an outside ozone generator. The ozone would be introduced into a stage of the existing gas flow treatment system upstream of at least a portion of the existing equipment, and typically after an existing SCR chamber (after removal of the catalyst to reduce draft loss and provide lower parasitic power demand and thereby be deactivated and serve as a drop-out chamber or conduit) and typically prior to a dry electrostatic precipitator (ESP) and/or a fabric filter (bag house), as shown in FIG. 1(c). Either of these or other similar treatment systems or particulate removal approaches is expected to allow the necessary residence time for the ozone to react with the nitrogen oxides in the air or gas flow;
The air or gas flow that exits the dry ESP or fabric filter is then passed into a wet flue gas desulfurization scrubber (FGD) designed to remove sulfur dioxide SO₂;
Next, direct the air or gas flow (after introduction of the ozone and reaction in the downstream equipment) exiting the FGD scrubber into a first stage of a wet ESP (which may be in the footprint of the FGD absorber/vessel, or downstream of the FGD) to remove liquid water from the gas flow produced as an output of a combustion process;
   As disclosed and/or described herein, the two-stage wet ESP may be placed on top of and within the perimeter of the FGD unit with the output of the two-stage wet ESP then directed into a CO₂ absorber or other optional equipment, before being directed into a smokestack or exhaust structure;
Direct the output of the first stage of a wet ESP into a second stage of a wet ESP to remove the ultrafine particulates present in the air or gas flow output by the first wet ESP device; and
Direct the output of the second stage wet ESP into an absorber to remove CO₂ or other pollutants from the air or gas flow (if desired);
   Instead of or in addition to a CO₂ absorber, other forms of air or gas treatment components may be utilized prior to release of the treated air or gas flow into the environment;
Direct the output of the treatment processes into a smokestack or other component to release the treated air or gas flow into the environment.

As disclosed, embodiments provide (among other benefits) a mechanism for eliminating the use of ammonia as a reagent added to an outgoing air or gas flow. This is a significant advantage, as there are risks and hazards associated with the on-site storage and use of ammonia, as discussed in the following.

At some combustion process sites (e.g., electrical generating plants), ammonia is stored on-site in one of three forms: (1) anhydrous form, (2) the aqueous form or (3) as a dry prilled urea form which is converted to ammonia based on process demand. The storage and use of anhydrous ammonia is the most dangerous. This is evident because upon original permit of such a siting, “kill zones” are usually mapped to determine what impact a catastrophic failure of a pressurized anhydrous ammonia storage tank would cause.

The use of either the storage and use of aqueous ammonia or of dry urea prill was developed and used to drastically reduce the size and/or eliminate the possibility of a kill zone. However, even those two replacement sources of ammonia present risks. Thus, one benefit of an embodiment of the disclosed and/or described processing flow is reduced reliance on potentially toxic materials as part of an air or gas flow treatment process.

As an additional feature of the combustion generated air or gas flow cleaning approach disclosed and/or described herein, implementation (including monitoring and control) of the components and processes used to modify an existing combustion process and associated air or gas flow treatment can be achieved by monitoring NOx emissions up the (smoke) stack and adjusting the ozone injection rate accordingly to result in a desired amount or level of reduction. This would involve in-field utilization of the disclosed approach and development of a control algorithm to determine the optimum ozone injection flow rate for use by a given electrical generating unit (egu).

One way to implement a control algorithm for the introduction of ozone is to update unit costs regularly or continuously for not only ozone and the value of prevailing current de-NOx regulation emission allowances (in dollars per ton), but also for the value of the green hydrogen produced/utilized to offset fossil fuel heat (if tax credits are available for production of green hydrogen). Further control on NOx emissions is possible by increasing the stoichiometric ratio of Ozone/NOx.

These various unit values can be entered into a given generating or manufacturing plants' distributed control system (DCS). The DCS can be programmed to periodically monitor/adjust ozone flow rate up or down so that relevant output information can be identified and utilized. This output data can be entered into the day ahead pricing model of the owner's egu (electric utility steam generating unit) to facilitate preparation of day ahead price bid submission which takes place within the various Regional Transmission Organizations (RTOs).

Embodiments of the disclosure may include use of disk-in-tube type “wet” or “dry” ESP (electrostatic precipitation) technology for the capture/removal of moisture and/or airborne particles as gas or air flow passes through an array of tubes or cylindrical electrodes. This provides an effective method of particulate removal without the inefficiencies associated with conventional filtering techniques and enhances the reliability/availability of a plant or system by eliminating the cost of a conventional SCR deNOx system. As mentioned, for existing plants, the existing SCR element may be deactivated and used as a drop-out chamber or removed, while for newly constructed plants, the SCR component may be eliminated.

Embodiments reduce and may eliminate both forced and planned outages associated with SCR catalyst cleaning and catalyst regeneration/replacement. Further, embodiments eliminate the inlet airstream blocking effect of a conventional filter, thus making an embodiment adaptable to different operating environments and processes (including a range of industrial manufacturing processes that may generate pollutants or other undesirable particulate matter).

In one embodiment a set or array of tubes or substantially hollow cylindrical elements is provided as part of a wet ESP, through which the air or gas flow is directed. Each tube contains two electrodes; a first represented by a central mast with disks placed along the length and a second represented by the inner wall of the tube (this form of electrode is known as a disk-in-tube arrangement). Upon application of a suitable potential difference between the electrodes, an electric field is established within the tube. The electric field is sufficient to ionize the air or gases and electrostatically charge substantially all the particulate matter in the entering air or gas stream. The ionized particles are then forced to the wall of the tube by the electric field and removed from the air or gas stream. In this way, the particulate matter is removed from the air or gas stream with minimal blockage of the air or gas flow.

The disk-in-tube arrangement enables the development of a relatively high voltage corona at a relatively high field strength. This is because the arrangement allows a highly focused electric field at the central mast/disks (the cathode) with a diffuse and uniform electric field at the cylindrical tube (the anode), thus preventing arc-over until relatively high electric field strengths are reached.

The ability to generate a relatively high electric field is important to the success achieved in using “wet” ESP based filtering in the field of air pollution control. For example, the technology may be used to abate emissions from various combustion processes that tend to emit significant concentrations of fine particulate matter. However, in this role the “wet” ESP units employed have been relatively large machines designed to deal with rapid accumulation of collected particulate matter and various other factors present in the abatement of manufacturing process emissions.

Such accumulations tend to limit the electric field strength because the physical structure of the material on the surface of the collecting electrode can become an electric “focal point” which then causes sparking. Thus, more accumulations result in sparking at lower electric field strength which limits particle-removal performance. As a result of these factors, the typical electric field strengths achievable have been equal to or less than approximately 20 kV/inch.

However, in the absence of heavy concentrations of particulate matter the tendency to form field-limiting accumulations on the collecting electrode surface is reduced and, accordingly, it is possible to operate the second stage of the wet ESP at much higher electric field strengths (i.e., voltage), resulting in a more efficient device. This also means that the second stage of the wet ESP would have better particle removal efficiency at higher velocities and/or lower treatment time.

As mentioned, the particle migration velocity (i.e., the velocity vector normal to the air or gas direction) increases as the square of the field strength. Thus, the migration velocity at 30 kV/inch is approximately 2.25 times the migration velocity at 20 kV/inch. This factor also applies to the precipitator size, so that a precipitator operating at the higher field strength would be this factor smaller (and presumably lighter) than one operating at 20 kV/inch (i.e., relative size=1/2.25=44.4%).

The higher electric field gradient provides the benefit of more effective air or gas stream filtering while making the resulting process more feasible to use in some operating environments and systems. The combination of reduced size coupled with increased electric field gradient provides both better performance and greater feasibility in certain use cases or operating environments (such as on a smokestack or within an existing component or structure).

In one embodiment, an ESP device may be augmented by introduction of one or more sensors to determine a velocity of the air or gas flow going through a tube or tubes, or an ensemble of tubes (such as by measuring air velocity in front of and after an ESP filtering device or structure). A sensor or sensors may also be used to measure the electric field within a characteristic tube or tubes and determine changes in the strength or uniformity of that field.

The sensor signal(s) may be used to determine an operating efficiency, detect sub-optimal electrode operation (due to degradation from particle impacts or particle accumulation), and be used as part of an adaptive feedback control loop to vary the operating parameters of the ESP device. This may provide a capability to dynamically alter certain operating parameters (such as voltage potential across the electrodes or relative gas flow speed at intake) to optimize performance under varying conditions of humidity, particulate type, or particulate concentration.

Additional details and information regarding the operation of such an ESP stage or device may be found in U.S. Pat. No. 10,890,113, issued Jan. 12, 2021, and titled “System, Apparatuses, and Methods for Improving the Operation of a Turbine Using Electrostatic Precipitation”, claiming priority to Provisional Patent Application No. 62/261,987 filed Dec. 2, 2015, the contents of which are hereby incorporated by reference into this specification in their entirety.

As mentioned, embodiments address both the recently enacted air quality and haze reduction regulations or guidelines, and the expected enaction of further restrictions on particulate emissions generated by industrial and manufacturing processes. This includes processes that generate electrical power through combustion, such as coal-fired power generators. Embodiments may be implemented as a retrofit to an existing power generating facility or as part of a design for a new facility.

Historically, and in response to regulations directed at reducing particulate matter emitted into the environment from industrial or power generation processes, the US coal fired power generation industry began implementing sulfur dioxide removal technologies, typically via wet flue gas desulphurization (FGD) processes. The original design concept of such FGD treatment processes developed a rule of thumb design criteria of ten feet per second (10 f/s) air or gas flow for the open area of the FGD process vessel. This value was adopted to ensure adequate residence time for the chemical reaction (scrubbing) process to achieve sufficiently high removal efficiencies for the sulfur dioxide content in the flue gas.

In such open vessels, there is a substantial amount of internal support structure for the needed reagent piping; this affects the gas velocity in the vessel. In addition, before the flue gas exits such a vessel, a set of mechanical mist eliminators (ME) are used to remove a significant portion of FGD slurry mist to minimize dropout in the lower velocity downstream areas (e.g., ductwork and wet stack) along with preventing localized “rainout” of particles near the plant site after the saturated flue gas exits the vessel.

The mist eliminators are dependent on uniform gas flow to permit operation below their respective “breakthrough” velocity, at which velocity they do not effectively remove the slurry mist. In addition, the eliminators are susceptible to becoming plugged and require counter flow spray wash systems to irrigate the flow path on a periodic basis to maintain adequate/proper operation.

Due to their limitations in removing fine particles with a sufficiently high removal efficiency, the mechanical mist eliminator devices provide little (if any) benefit in addressing the issue of the formation of detached plumes which occur beyond the immediate location of an industrial plant. This is the crux of an important issue associated with coal fired power generating plants and their contribution to regional haze formation. The mechanical mist eliminator systems are a dated approach that is unable to adequately address the need to capture small particle carryover out of a FGD vessel.

Currently, most of the remaining coal fired power generating facilities use vertical gas flow up into an open spray tower FGD process vessel. However, the exit velocity of the flue gas is too high to adequately reduce concentrations of certain pollutants using a conventional wet electrostatic precipitator technology within the confines of the FGD vessel.

In this regard, embodiments provide an efficient and practical solution that is reasonable in terms of both cost and scheduled outage time needed for installation/retrofit, while also causing a significant reduction in system pressure drop and fan horsepower requirements. As one example, removing the catalyst from the SCR provides a reduction in parasitic load consumption associated with the operation of the induced draft fan on the unit. A similar principle applies to removing the mechanical mist eliminator system from the wet scrubber absorber vessels.

Embodiments implement a technical solution that operates to maximize the removal of the free moisture present in flue gas or air flow in a first stage of a wet ESP to allow a relatively high operating voltage in the second stage of the wet ESP and thereby enhance the removal efficiency for the very fine particles in the flue gas before it is released into the environment.

As also mentioned, eliminating the use of ammonia and SCR technology with the associated ammonia “slip” to prevent the formation of detached ammonium salt plumes downstream of a plant is a valuable benefit of implementing an embodiment. Going forward, if required, an additional benefit of embodiments is that of providing the cleanest flue gas stream possible, i.e. the best system of emission reduction prior to exiting into the environment or prior to input of the flue gas to a CO2 removal process technology.

The disclosed and/or described two-stage wet ESP approach coupled with the use of ozone as a reductant for control of NOx emissions overcomes limitations inherent in the use or reuse of existing treatment vessels and provides a more optimal solution to particulate management pursuant to the requirements of the Regional Haze Rule.

Regional haze is a visibility impairment that is produced by a multitude of anthropogenic sources and activities and affects a broad geographic area. Such haze may result from not only very fine discreet particles emanating from smokestack industries but also the formation of downwind detached plumes that significantly impair visibility as well. Such detached plumes are a result of both physical and chemical reactions taking place in a combustion process coupled with the use of ammonia and possibly the use of other add on treatments, e.g., halogenated activated carbon and other proprietary chemical additives as well.

However, inability to comply with various environmental regulations is resulting in the closure of numerous thermal (primarily coal fired) power generating plants. These closures are prevalent even before more onerous air pollution control rules and regulations compliance dates are vetted/implemented, e.g., the Cross State Air Pollution Control Rule (CSAPR), updates associated with Mercury and Air Toxics (MATS) and the ratcheting down of PM 2.5 standards. The situation is further complicated by the fact that going forward there is a need for significantly more electrical power to meet the needs of the data storage and artificial intelligence marketplace which is creating an unparalleled growth rate of demand for electricity over a short time frame.

The disclosed and/or described approach addresses these needs and provides a solution to the problem of Regional Haze formation, thereby also eliminating the need for periodic reviews and revisions of processing methods. These benefits are achieved with less parasitic electrical load on the induced draft fan and the fly ash generated during gas or airflow processing has less carbon content than that presently generated. Both improvements can provide a significant monetary benefit to the owner of an industrial or power generating plant.

As mentioned, historically, conventional air pollution control technologies currently in use employ chemical additives for MATS Compliance coupled with physical mist elimination devices in SO₂ wet scrubbing applications. Embodiments represent a transformative approach to drastically improve removal of fine particles including metal hazardous air pollutants, along with a reduction in carbon monoxide (a primary pollutant), and a drastic reduction in the emission of very fine carbon particles emanating from the smokestack, thus reducing or eliminating downwind ammonium salt formation.

The Regional Haze Rule is established law and not being challenged in the Courts. As is, the states have a periodic requirement (every 10 years) to assess whether they are achieving progress in their Regional Haze State Implementation Plan (SIP) to achieve compliance by the year 2064. Embodiments provide a mechanism for satisfaction of this haze rule or regulation, and are believed to represent a long-term solution to the problem of reducing the emission of particulate matter from an electrical generation or industrial process.

The disclosure includes the following clauses and embodiments:
1. A method for treating a gas flow to reduce particulate emissions, comprising:
   introducing ozone into a gas flow produced as an output of a combustion process that is part of an industrial, power generation, or manufacturing process;
   directing the gas flow after introduction of the ozone into a wet flue gas desulfurization scrubber (FGD) unit;
   directing the gas flow after treatment in the FGD unit into a first stage of a wet electrostatic precipitator (ESP) device to substantially remove liquid water from the gas flow;
   directing an output of the first stage of the wet ESP device into a second stage of a wet ESP device to substantially remove particulates from the gas flow output by the first wet ESP device; and
   directing an output of the second stage of the wet ESP device into a structure or component to release the gas flow into the environment.
2. The method of clause 1, wherein the output of the second stage of the wet ESP device is directed into an absorber designed to remove one or more pollutants from the gas flow and the output of the absorber is directed into the structure or component to release the gas flow into the environment.
3. The method of clause 1, wherein the industrial, power generation, or manufacturing process includes a gas flow treatment system consisting of one or more of a dry electrostatic precipitator and a fabric filter positioned downstream of where the ozone is introduced.
4. The method of clause 2, wherein the absorber removes CO₂ from the gas flow.
5. The method of clause 1, wherein the gas flow after treatment by the wet flue gas desulfurization scrubber has a vertical up flow with a bulk gas velocity of approximately 10 ft/second or greater.
6. The method of clause 1, wherein the ozone is introduced at a rate that is at least twice the molar ratio of nitrogen oxides in the gas flow.
7. The method of clause 1, wherein one or both of the first stage of the wet electrostatic precipitator (ESP) device and the second stage of the wet electrostatic precipitator (ESP) device are comprised of a plurality of tubular or cylindrical elements.
8. The method of clause 1, wherein the combustion process is performed by one of a steam boiler, a combustion turbine, a kiln, or a reheat furnace.
9. The method of clause 3, wherein the gas flow treatment system includes a selective catalytic reduction (SCR) system that is subjected to removal of its catalyst and operates as a drop out chamber.
10. A system for removing particulate matter from a gas flow, comprising:
   a chamber in which a material is combusted, wherein the combustion in the chamber produces a gas flow;
   an ozone generator operating to introduce ozone into the produced gas flow;
   a wet flue gas desulfurization scrubber (FGD) unit positioned to receive the gas flow after introduction of the ozone;
   a first stage of a wet electrostatic precipitator (ESP) device positioned to receive the gas flow after treatment by the FGD unit and operating to substantially remove liquid water from the gas flow;
   a second stage of a wet ESP device operating to substantially remove particulates from the gas flow output by the first stage of the wet ESP device and into which an output of the first stage of the wet ESP device is directed; and
   a structure or component to release the gas flow into the environment.

While embodiments of the disclosure have been described in connection with what is presently considered to be the most practical approach and technology, the embodiments are not limited to the disclosed implementations. Instead, the disclosed implementations are intended to include and cover modifications and equivalent arrangements included within the scope of the appended claims. Although specific terms are employed herein, they are used in a generic and descriptive sense only and not for purposes of limitation.

This written description uses examples to describe one or more embodiments of the disclosure, and to enable a person skilled in the art to practice the disclosed approach and technology, including making and using devices or systems and performing the associated methods. The patentable scope of the disclosure is defined by the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference was individually and specifically indicated to be incorporated by reference and/or was set forth in its entirety herein.

The use of the terms “a” and “an” and “the” and similar references in the specification and in the claims are to be construed to cover both the singular and the plural, unless otherwise indicated herein or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated herein, and each separate value is incorporated into the specification as if it were individually recited herein. Method steps or stages disclosed and/or described herein may be performed in any suitable order unless otherwise indicated herein or clearly contradicted by context.

The use of examples or exemplary language (e.g., “such as”) herein, is intended to illustrate embodiments of the disclosure and does not pose a limitation to the scope of the claims unless otherwise indicated. No language in the specification should be construed as indicating any non-claimed element as essential to each embodiment of the disclosure.

As used herein (i.e., the claims, figures, and specification), the term “or” is used inclusively to refer items in the alternative and in combination.

Different arrangements of the elements, structures, components, or steps illustrated in the figures or described herein, as well as components and steps not shown or described are possible. Similarly, some features and sub-combinations are useful and may be employed without reference to other features and sub-combinations. Embodiments have been described for illustrative and not for restrictive purposes, and alternative embodiments may become apparent to readers of the specification. Accordingly, the disclosure is not limited to the embodiments described in the specification or depicted in the figures, and modifications may be made without departing from the scope of the appended claims.

That which is claimed is:

1. A method for treating a gas flow, comprising:
introducing ozone into a gas flow produced as an output of a combustion process that is part of an industrial, power generation, or manufacturing process;
directing the gas flow after introduction of the ozone into a wet flue gas desulfurization scrubber (FGD) unit;
directing the gas flow after treatment in the FGD unit into a first stage of a wet electrostatic precipitator (ESP) device to substantially remove liquid water from the gas flow;
directing an output of the first stage of the wet ESP device into a second stage of a wet ESP device to substantially remove particulates from the gas flow output by the first wet ESP device; and
directing an output of the second stage of the wet ESP device into a structure or component to release the gas flow into the environment.

2. The method of claim 1, wherein the output of the second stage of the wet ESP device is directed into an absorber designed to remove one or more pollutants from the gas flow and the output of the absorber is directed into the structure or component to release the gas flow into the environment.

3. The method of claim 1, wherein the industrial, power generation, or manufacturing process includes a gas flow treatment system consisting of one or more of a dry electrostatic precipitator and a fabric filter positioned downstream of where the ozone is introduced.

4. The method of claim 2, wherein the absorber removes CO₂ from the gas flow.

5. The method of claim 1, wherein the gas flow after treatment by the wet flue gas desulfurization scrubber has a vertical up flow with a bulk gas velocity of approximately 10 ft/second or greater.

6. The method of claim 1, wherein the ozone is introduced at a rate that is at least twice the molar ratio of nitrogen oxides in the gas flow.

7. The method of claim 1, wherein one or both of the first stage of the wet electrostatic precipitator (ESP) device and the second stage of the wet electrostatic precipitator (ESP) device are comprised of a plurality of tubular or cylindrical elements.

8. The method of claim 1, wherein the combustion process is performed by one of a steam boiler, a combustion turbine, a kiln, or a reheat furnace.

9. The method of claim 3, wherein the gas flow treatment system includes a selective catalytic reduction (SCR) system that is subjected to removal of its catalyst and operates as a drop out chamber.

10. A system for removing particulate matter from a gas flow produced by a combustion process that is part of an industrial or manufacturing process, comprising:
a chamber in which a material is combusted, wherein the combustion in the chamber produces a gas flow;
an ozone generator operating to introduce ozone into the produced gas flow;
a wet flue gas desulfurization scrubber (FGD) unit positioned to receive the gas flow after introduction of the ozone;
a first stage of a wet electrostatic precipitator (ESP) device positioned to receive the gas flow after treatment by the FGD unit and operating to substantially remove liquid water from the gas flow;
a second stage of a wet ESP device operating to substantially remove particulates from the gas flow output by the first stage of the wet ESP device and into which an output of the first stage of the wet ESP device is directed; and
a structure or component to release the gas flow into the environment.

11. The system of claim 10, wherein the output of the second stage of the wet ESP device is directed into an absorber designed to remove one or more pollutants from the gas flow and the output of the absorber is directed into the structure or component to release the gas flow into the environment.

12. The system of claim 10, wherein the industrial, power generation, or manufacturing process includes a gas flow treatment system consisting of one or more of a dry electrostatic precipitator and a fabric filter positioned downstream of where the ozone is introduced.

13. The system of claim 11, wherein the absorber removes CO₂ from the gas flow.

14. The system of claim 10, wherein the gas flow after treatment by the wet flue gas desulfurization scrubber has a vertical up flow with a bulk gas velocity of approximately 10 ft/second or greater.

15. The system of claim 10, wherein the ozone is introduced at a rate that is at least twice the molar ratio of nitrogen oxides in the gas flow.

16. The system of claim 10, wherein one or both of the first stage of the wet electrostatic precipitator (ESP) device and the second stage of the wet electrostatic precipitator (ESP) device are comprised of a plurality of tubular or cylindrical elements.

17. The system of claim 10, wherein the combustion process is performed by one of a steam boiler, a combustion turbine, a kiln, or a reheat furnace.

18. The system of claim 12, wherein the gas flow treatment system includes a selective catalytic reduction (SCR) system that is subjected to removal of its catalyst and operates as a drop out chamber.
